(19) United States
(12) Patent Application Publication
(10) Pub. No.: US 2023/0321874 A1
(43) Pub. Date: Oct. 12, 2023

(54) DEVICE AND METHOD FOR MIXING AT LEAST TWO CHEMICALLY REACTIVE PLASTICS COMPONENTS

(71) Applicant: KRAUSSMAFFEI TECHNOLOGIES GMBH, München (DE)

(72) Inventors: Patrick SCHWEISSTHAL, München (DE); Robert BRUNNER, Augsburg (DE); Alexander BERG, Dachau (DE); Ralf MOSER, München (DE); Jens KOMPE, Windach (DE)

(21) Appl. No.: 18/041,224

(22) PCT Filed: Jul. 26, 2021
(86) PCT No.: PCT/EP2021/070896

§ 371 Date: Feb. 10, 2023

(30) Foreign Application Priority Data
Sep. 9, 2020 (DE) 10 2020 123 521.6

(51) Int. Cl. B29B 7/76; B29B 7/72

(52) U.S. Cl. CPC B29B 7/7694; B29B 7/7642; B29B 7/728

(57) ABSTRACT

Device for mixing at least two chemically reactive plastics components under pressure, having a mixing chamber, into which the plastics components are injected in each case by way of a component-feeding opening, wherein a reversible control piston is provided for opening and closing the component-feeding openings and for discharging plastics mixture remaining within the mixing chamber, wherein the control piston is connected to an electric drive. Alternatively, in the case of a transfer mixing head, the cleaning piston may be coupled to an electric drive. A method for operating such a mixing head is also disclosed.

### TECHNICAL FIELD

The invention relates to a device and a method for mixing at least two chemically reactive plastics components under pressure, having a cylindrical mixing chamber into which the plastics components are injected in each case by way of a component-feeding opening, wherein a reversible control piston is arranged for opening and closing the component-feeding openings and for discharging plastics mixture remaining within the mixing chamber.

### PRIOR ART

Generic mixing heads are already known from the prior art. For example, DE 195 1 039 A1 discloses a device for mixing at least two chemically reactive plastics components under high pressure, having a cylindrical mixing chamber into which the components are injected, wherein a reversible piston is arranged for discharging plastics mixture remaining within the mixing chamber. The device also has a cylindrical outlet chamber, also designated as a settling chamber or outlet channel, which adjoins the mixing chamber and runs at an angle of preferably 90° to the longitudinal axis of the mixing chamber, wherein in the settling chamber a reversible cleaning piston is arranged for discharging the reactive plastics mixture from the settling chamber. The cleaning piston has depressions, formed on its cylindrical outer surface, which depressions are filled with spacing material and are arranged in a spiral-shaped manner on the outer surface, so that on an axial movement of the cleaning piston this is set in rotation.

DE 36 29 042 C1 describes a mixing head for producing a chemically reacting mixture of at least two components, in particular of a mixture of isocyanate and polyol reacting out to polyurethane, which has a bore with an axially displaceable tappet and, in the wall of the bore, for the formation of a mixing chamber, two nozzles for the feeding of the components. The tappet conveys the produced mixture out of the bore. The axially displaceable tappet has a cylindrical cross-section and is coupled with a rotary drive. The axially displaceable tappet can also be coupled with a drive oscillating about its axis. If the axially displaceable tappet has a prismatic cross-section, it is coupled with a drive oscillating in axial direction of the tappet.

Both the control piston and also the cleaning piston are hydraulically driven in the known solutions. These can thus be easily moved into a predefined end position, wherein each change of the end position causes a modification on the machine. The hydraulics also require additional components, in order to build up and maintain the necessary hydraulic pressure.

### DESCRIPTION OF THE INVENTION

It is an object of the present invention to create a solution by which a flexible manufacture with reactive plastics components is enabled and which solves or improves the known challenges.

The problem is solved by the subjects of the independent claims. Advantageous further developments of the invention are indicated in the dependent claims, the description and the accompanying figures. In particular, the independent claims of one claim category can also be further developed in an analogous manner to the dependent claims of another claim category.

A device according to the invention for mixing at least two chemically reactive plastics components under pressure has a cylindrical mixing chamber, into which the plastics components are injected in each case by way of a component-feeding opening. A reversible control piston is arranged within the mixing chamber for opening and closing the component-feeding openings and for discharging remaining plastics mixture. The control piston is—mechanically—connected to an electric drive. A movement of the electric drive thus brings about a movement of the control piston.

A component-feeding opening can also be understood as a component nozzle or an inoculation bore. A first chemically reactive plastics component is fed under pressure to the mixing chamber through a first component-feeding opening, a second chemically reactive plastics component is fed under pressure to the mixing chamber through a second component-feeding opening. The two plastics components, fed under pressure, intermix in the mixing chamber. The control piston is set up to close the two component-feeding openings and, at the same time, to open them, so that the two plastics components (can) flow into the mixing chamber. The control piston moves in the mixing chamber in a linear manner. The electric drive can be, for example, an electric motor, an electro-magnetic drive or a linear motor.

The control piston is coupled with the electric drive, for example directly (direct drive), via a gearing, a belt drive (belt or chain), bevel gear and/or via a coupling. The motor shaft can optionally also be formed in one piece with the downstream coupling elements such as a spindle.

The mixing chamber is formed in such a way that the control piston can be moved linearly therein. The inner contour of the mixing chamber thus corresponds to an outer contour of the control piston. A cylindrical mixing chamber is to be understood as a shape corresponding to a general cylinder, therefore not only a circular cylinder with a circle as base area. Other geometric shapes such as a rectangle or polygons, but also free closed curves are also conceivable as surrounding the base area.

Through the use of an electric drive, the activation of the device can be simplified and thus changes in the production can be reacted to more easily.

The electric drive can be configured here to generate a rotational movement. The electric drive can be connected to the control piston via a coupling device. Thus, the coupling device can therefore couple the electric drive with the control piston, wherein the electric drive carries out a rotational movement and the control piston carries out a linear movement. The coupling device is configured to convert the rotational movement of the electric drive into a linear movement of the control piston. The coupling device can have a spindle or a rack. A widely available electric motor can thus be used as electric drive for driving the linearly moving control piston.

The coupling device can be configured as a spindle-nut combination with or without self-locking. The relative movement of the control piston to the device can take place through a relative rotation of spindle and spindle nut. Here, either the spindle or the spindle nut can be rotatably driven by the electric drive.

By a spindle-nut combination, or respectively spindle-spindle nut combination, being used, in particular when this has a self-locking, a very good control is provided over all movements of the control piston. In contrast to hydraulically driven control pistons, there does not have to be any fear of an overhasty action of the control piston in the case of a decreasing counter force. Rather, the electrically operated control piston continues its path in a controlled manner independent of force. By the relative rotation of spindle and spindle nut, a rotational movement of the electric drive is converted into a linear movement—of the control piston.

A gearing can be arranged between the electric drive and the motor-driven part of the spindle-nut combination. With such a gearing, the application of force onto the control piston can be produced in a desired range according to the drive performance of the electric drive.

Here, the electric drive can be configured as a servo motor or stepping motor. The electric drive can be connected to a spindle via a coupling, and can set the spindle into a rotational movement. The spindle can drive a spindle nut. The spindle nut can be moved (linearly) along the spindle by a rotational movement. The rotation direction thus influences the movement direction of the spindle nut. The spindle nut can be connected to the control piston via a thrust tube. The spindle nut can thus be coupled with the thrust tube and the thrust tube can be coupled with the control piston.

A bearing device can support the spindle. The bearing device can be arranged between the coupling and the spindle nut. The bearing device can be formed as an angular ball bearing. The bearing device can support axially and additionally or alternatively can support radially. The bearing device can thus have axial bearings, radial bearings, radiaxial bearings and/or linear bearings. The bearing device can have a number of bearings such as sliding bearings or roller bearings, in particular with balls, cylinder, needles, barrels or cones as rolling bodies, therefore ball bearings, rolling bearings, roll bearings, needle bearings.

Alternatively, the spindle can be formed as an inverted spindle. The electric drive can be connected here via a coupling to a spindle nut, which drives the spindle. The spindle can be connected to a thrust tube which is coupled to the control piston.

A bearing device can be provided which supports the spindle nut. The bearing device supporting the spindle nut can be formed as an angular ball bearing. The bearing device can support axially and, additionally or alternatively, can support radially. The bearing device can thus have axial bearings, radial bearings, radiaxial bearings and/or linear bearings. The bearing device can have a number of bearings such as sliding bearings or roller bearings, in particular with balls, cylinder, needles, barrels or cones as rolling bodies, therefore ball bearings, rolling bearings, roll bearings, needle bearings.

The device can also be configured as a transfer mixing head. Here, additionally, a cleaning piston is provided. A cylindrical outlet chamber adjoins the mixing chamber. In the outlet chamber, partly also designated as settling chamber, the reversible cleaning piston is arranged for discharging the reactive plastics mixture from the outlet chamber. The control piston and the cleaning piston are preferably arranged transversely with respect to one another, in particular when the outlet chamber runs at an angle of 90° to the longitudinal axis of the mixing chamber. The arrangement at right-angles, or respectively transversely to one another, constitutes an arrangement which is proven in practice. A Y-arrangement or an arrangement in an angle range of +/−30° to the right angle constitute possible arrangements.

Analogously or alternatively to the control piston, the cleaning piston can be driven electrically, as is already presented above for the control piston. The cleaning piston can thus be coupled with a—further—electric drive. The cleaning piston is set up to carry out a linear movement in the outlet chamber. A further spindle-nut combination can thus be provided, via which the cleaning piston is driven by the further electric drive. A (first) thrust tube can thus be coupled with the control piston, and a further (second) thrust tube can be coupled with the cleaning piston. As described in detail above, a rotation direction of the electric drive respectively brings about a linear movement direction of the control piston or respectively of the cleaning piston. The embodiments for connecting and bearing the control piston are also applicable or respectively able to be used in an analogous manner accordingly for the cleaning piston. The inventive idea can be implemented when only the cleaning piston or only the control piston, or when both pistons, are driven electrically.

The thrust tube, associated with the control piston, can be equipped with an anti-rotation device, which prevents a co-rotating of the thrust tube with the spindle. Likewise, the (further) thrust tube, associated with the cleaning piston, can be equipped with an anti-rotation device, which prevents a co-rotating of the thrust tube with the spindle.

The inventive idea can also be implemented in a method for mixing at least two plastics components. The at least two chemically reactive plastics components are injected under pressure into a cylindrical mixing chamber in each case by way of a component-feeding opening. A reversible control piston is arranged within the mixing chamber for opening and closing the component-feeding openings and for discharging remaining plastics mixture. The control piston is connected to an electric drive and is driven by the latter.

Furthermore, a cleaning piston can be provided, having an outlet chamber which adjoins the mixing chamber, wherein in the outlet chamber the cleaning piston is arranged for discharging the reactive plastics mixture from the outlet chamber. The cleaning piston is moveable reversibly or in other words linearly in the outlet chamber. The cleaning piston is connected to an electric drive and is driven by the latter.

A current position of the cleaning piston and additionally or alternatively a current position of the control piston can be determined, and thus a controlling of the cleaning piston and/or of the control piston can take place using the respective determined current position. Through the use of the determined position, a position control (closed loop) can take place. Thereby, a very precise approach of the desired position is possible, as a target position can be compared with the actual position (i.e. the determined position) at any time. For position determining, a measurement value can be detected which represents the current position.

Depending on the design of the spindle-nut combination in connection with the electric drive (electric motor), the force-path course can be controlled very finely on movement of the control piston and/or of the cleaning piston. Also, all movement parameters can be established in a functionally accurate manner and maintained accurately during operation by high-resolution path measurement devices in connection with the currently available electric servo motor technology.

A control device can be provided which actuates the electric drives and is set up to carry out steps of the method which is presented here. The control device can be set up to emit control signals for actuating the electric drive or the electric drives. Furthermore, it can be set up to receive and process measurement values for determining position.

A throttle position of the cleaning piston can be varied via an activation of the electric drive which is associated with the cleaning piston. The activation can take place directly from the control device of the cleaning piston or respectively of the electric drive, and a manual re-measuring of the throttle position is no longer necessary.

A speed profile of the cleaning piston and/or a speed profile of the control piston can be varied as a function of the produced part.

The electric drive associated with the control piston can be actuated in such a way that the control piston approaches an intermediate position, in order to flush rerouting grooves in the control piston. The rerouting grooves are also designated as recirculation grooves. The rerouting grooves serve to direct the plastics component from the component-feeding opening to a return, in order to be able to move the plastics component under pressure in the system, so that on opening of the component-feeding opening, the plastics component flows into the mixing chamber without dead time with the desired and set pressure. In the intermediate position, regions can now be flushed which otherwise are only rarely flowed through with material.

A torque and/or a rotation speed and/or an electric current consumption of the electric drive of the cleaning piston and/or of the electric drive of the control piston or electric signals representing these can be monitored. Using the rotation speed and/or the torque and/or the electric current consumption, a wear parameter can be determined for prospective maintenance. The electric signal(s), which represent the torque and/or the rotation speed and/or the electric current consumption of the electric drive, can be monitored for maintaining a threshold value, and on exceeding (or falling below) the predefined threshold value, an alarm signal can be emitted. This can be implemented for example simply by means of a comparator. Alternatively, an AI system can be taught-in and used in order to obtain information for prospective maintenance.

The above explanations concerning the method apply to the device accordingly and vice versa. The control device for controlling the electric drives can be embodied in one component or distributed in several components. Furthermore, the control device can be integrated into an ASIC or a comparable integrated circuit (mC, FPGA, . . . 0). The control device can generally also be understood as a control apparatus. The control device which is mentioned here can be embodied in particular as a processor unit and/or an at least partially hardwired or logic switching arrangement for the metrological steps and steps for actuating the electric drives of the described method. Said control device can be or comprise any type of processor or calculator or computer with correspondingly necessary periphery (memory, input/output interfaces, input-output devices, etc.).

### BRIEF DESCRIPTION OF THE FIGURES

Such a device and such a method for mixing at least two chemically reactive plastics components are to be described more closely in the following with reference to the figures. The following description is, however, to be regarded as purely by way of example. The invention is determined solely through the subject of the claims. An advantageous example embodiment of the invention is explained below with reference to the accompanying figures. There are shown:

FIG. 1a sectional illustration of a device for mixing at least two chemically reactive plastics components according to a first example embodiment of the present invention;

FIG. 2a sectional illustration of a device for mixing at least two chemically reactive plastics components along the section line CC of FIG. 1 according to the first example embodiment of the present invention;

FIG. 3a sectional illustration of a device for mixing at least two chemically reactive plastics components according to a second example embodiment of the present invention;

FIG. 4a sectional illustration of a device for mixing at least two chemically reactive plastics components according to a third example embodiment of the present invention;

FIG. 5a sectional illustration of the third example embodiment in a closed position; and

FIG. 6a detail enlargement of the sectional illustration of FIG. 5.

The figures are only schematic illustrations and serve only to explain the invention. Elements which are identical or equivalent are provided with the same reference numbers throughout.

### DETAILED DESCRIPTION

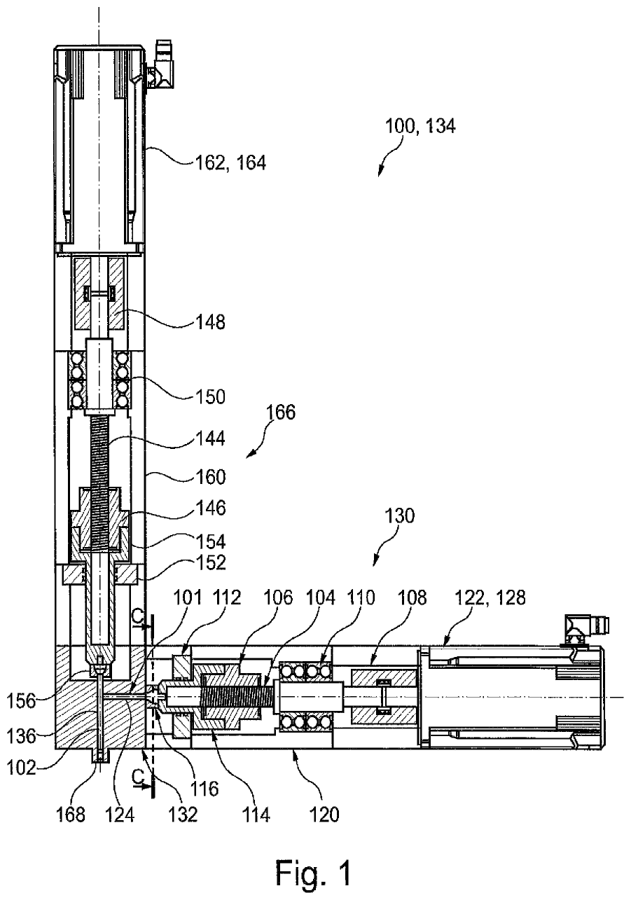

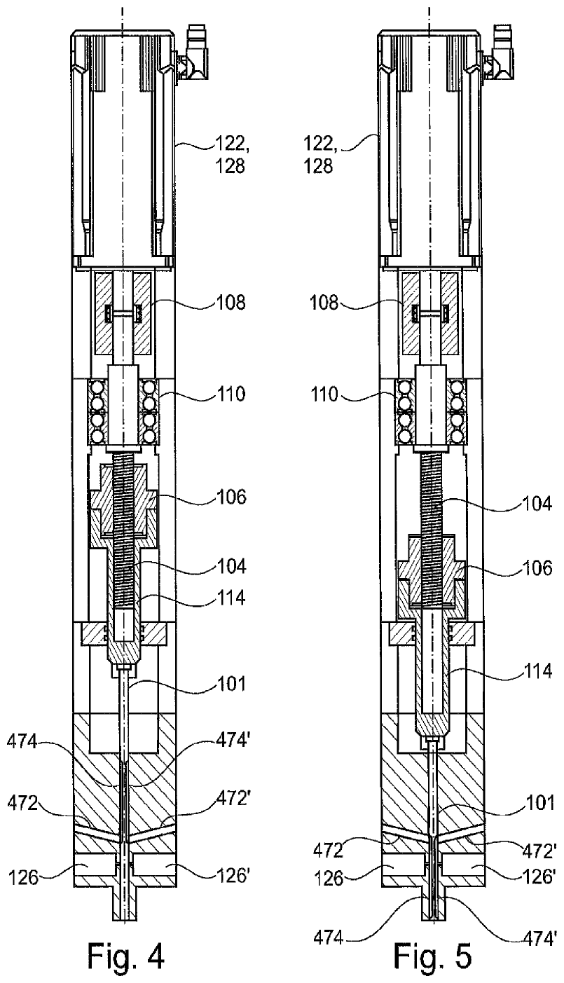

FIG. 1 shows a sectional illustration of a device 100 for mixing at least two chemically reactive plastics components according to a first example embodiment of the present invention. The device 100 can also be designated as a mixing head device for a reaction casting machine. In the present example embodiment, the device 100 is illustrated as a transfer mixing head 134 with a control piston 101 and with a cleaning piston 102. A (first) spindle (104), a (first) spindle nut 106, a (first) coupling 108, a (first) bearing device 110, a (first) sealing flange 114, a (first) anti-rotation device 116 and a (first) housing 120 are associated with the control piston 101. This part of the device is completed by a (first) electric drive (122). The “first” is respectively put in brackets, since, as becomes clear in the third example embodiment illustrated in FIG. 4 and FIG. 5, in a linear mixing head—without cleaning piston and without associated outlet chamber also all the named elements are present only once, so that a division into first and second is superfluous.

The device 100 is set up for mixing at least two chemically reactive plastics components. The two different plastics components are injected under pressure into the substantially cylindrical mixing chamber 124 via two component-feeding openings 126, 126′ which are not illustrated in FIG. 1. For opening, on the one hand, and on the other hand for closing the component-feeding openings 126, 126′, the control piston 101 is arranged in the mixing chamber 124. The control piston 101 also serves for the discharging of remaining plastics mixture from the mixing chamber 101. The control piston 101 is movable linearly within the mixing chamber 124. For this, the control piston 101 is coupled with the electric drive 122.

In the example embodiment, the electric drive 122 is formed as a servo motor 128. The latter generates a rotation movement. The servo motor 128 is connected to the control piston 101 via a coupling device 130 and moves the latter linearly on a rotation movement of the servo motor 128. The coupling device 130 is therefore configured to convert the rotation movement of the electric drive 122 into a linear movement of the control piston 101. A direction reversal of the rotation brings about a direction reversal of the linear movement. For this, the coupling device 130 comprises the spindle 104 and spindle nut 106 acting together in a spindle-nut combination. The servo motor 128 is connected to the spindle 104 via the coupling 108. In an example embodiment which is not illustrated, a gearing is additionally arranged between spindle 104 and servo motor 128. By the rotation of the spindle 104, brought about by the servo motor 128, the non-rotating spindle nut 106 is moved linearly relative to the spindle 104. The spindle nut 106 is coupled to the control piston 101 via the thrust tube 114.

The bearing device 110, supporting the spindle 104, is arranged between the coupling 108 and the spindle nut 106. In the example embodiment, the bearing device 110 is configured as an angular ball bearing receiving both axial and also radial forces. Depending on the length of the spindle, the number of bearings can be increased. Thus, in the illustrated example embodiment, two bearings are used.

The sealing flange 112 is arranged on the outer circumference of the thrust tube, which sealing flange seals towards the housing 120.

The mixing chamber 124, in which the control piston 101 is arranged in a reversible manner, is arranged in a head piece 132. The example embodiment illustrated in FIG. 1 concerns a transfer mixing head 134. In the head piece 132 an outlet chamber 136 is formed. This is aligned transversely to the mixing chamber 124. The cleaning piston 102 is arranged in the outlet chamber 136 in a reversible manner.

The structure of the cleaning piston 102 is completed by a (second) spindle 144, a (second) spindle nut 146, a (second) coupling 148, a (second) bearing device 150, a (second) sealing flange 152, a (second) thrust tube 154, a (second) anti-rotation device 156 and a (second) housing 160. Furthermore, this part of the device has a (second) electric drive 162. The structure of the further, or respectively second, elements associated with the cleaning piston 102 is analogous to the control piston 101, as already described above.

The cleaning piston 102 also serves for the discharging of remaining plastics mixture from the outlet chamber 136. The cleaning piston 102 is linearly movable within the outlet chamber 136. For this, the cleaning piston 102 is connected to the further or second electric drive 162.

In the example embodiment, the electric drive 162 is configured as a servo motor 164. The latter generates a rotation movement. The servo motor 164 is connected via a coupling device 166 to the cleaning piston 102 and moves the latter linearly on a rotation movement of the servo motor 164. The coupling device 166 is therefore configured to convert the rotation movement of the electric drive 162 into a linear movement of the cleaning piston 102. A direction reversal of the rotation brings about a direction reversal of the linear movement. For this, the coupling device 166 comprises the spindle 144 and spindle nut 146, acting together in a spindle-nut combination. The servo motor 164 is connected via the coupling 148 with that of the spindle 144. In an example embodiment which is not illustrated, a gearing is additionally arranged between spindle 144 and servo motor 164. By the rotation of the spindle 144 brought about by the servo motor 164, the non-rotating spindle nut 146 is moved linearly relative to the spindle 144. The spindle nut 146 is coupled to the cleaning piston 102 via the thrust tube 154.

The bearing device 150, supporting the spindle 144, is arranged between the coupling 148 and the spindle nut 146. In the example embodiment, the bearing device 150 is configured as an angular ball bearing receiving both axial and also radial forces.

On the outer circumference of the anti-rotation device 156, the sealing flange 152 is arranged, which seals towards the housing 160.

A mixing head outlet 168 is formed at the end of the outlet chamber 136.

FIG. 1 shows both the control piston 101 and also the cleaning piston 102 in the closed state, so that remaining plastics mixture was discharged both from the mixing chamber 124 and also from the outlet chamber 136.

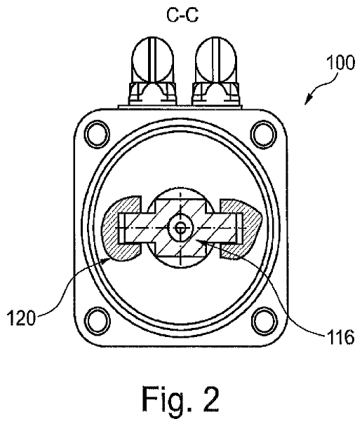

FIG. 2 shows a sectional illustration of a device for mixing at least two chemically reactive plastics components along the section line CC of FIG. 1 according to the first example embodiment of the present invention. The interaction of housing 120 and anti-rotation device 116 can be readily seen.

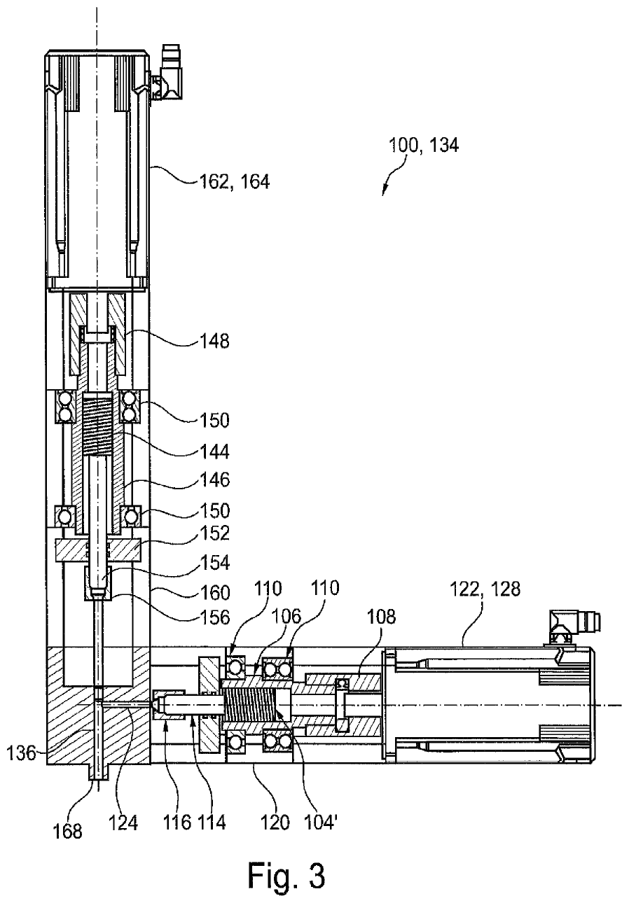

FIG. 3 shows a sectional illustration of a device for mixing at least two chemically reactive plastics components according to a second example embodiment of the present invention. The second example embodiment differs from the first example embodiment illustrated in FIG. 1 by the embodiment with an inverted spindle 104, 144. The first electric drive 122 is coupled to the first spindle nut 106 via the first coupling 108. The rotating first spindle nut 106 drives the first spindle 104 (linearly). The first spindle 104 drives the control piston 101 via the first thrust tube 114. Likewise, the second electric drive 162 is coupled to the second spindle nut 146 via the second coupling 148. The rotating second spindle nut 146 drives the second spindle 144 (linearly). The second spindle 144 drives the cleaning piston 102 via the second thrust tube 154. The thrust tube can also be formed as a thrust rod, as illustrated in the example embodiment.

FIG. 4 and FIG. 5 show a device 100 according to a third example embodiment of the present invention. FIG. 4 shows here a linear mixing head 470. In contrast to the transfer mixing heads illustrated in FIG. 1 and FIG. 3, an outlet chamber and the associated cleaning piston are dispensed with here. The component-feeding openings 126, 126′, standing perpendicularly to the plane of the image in FIG. 1 and FIG. 3 and therefore not depicted there, and a respectively associated return channel 472, 472′ are in the head piece 132. Together with the rerouting grooves 474, 474′ formed in the control piston 101, also designated as redirecting grooves, a circuit is produced for the respective chemically reactive plastics component. The first chemically reactive plastics component is directed via the first component-feeding opening 126 with closed control piston 101 via the first rerouting groove 474 to the first return channel 472. A pump, which is not illustrated, delivers the set quantity of the first chemically reactive plastics component with the predefined pressure. On opening of the control piston 101, the component-feeding openings 126, 126′ are opened and the chemically reactive plastics components flow with the already existing pressure into the mixing chamber. In the chamber upstream of the component-feeding opening 126, additionally a (controllable) nozzle or component-feeding nozzle can be arranged.

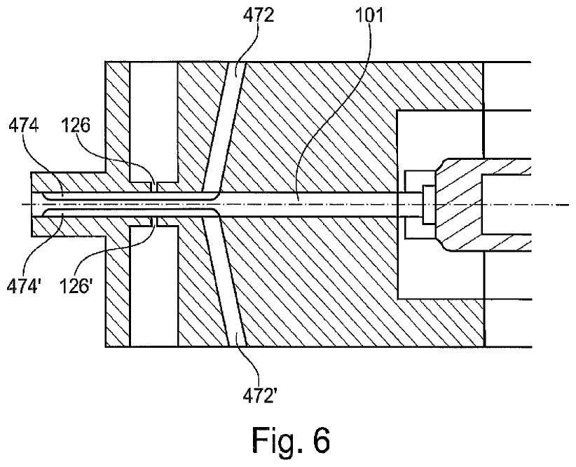

The configuration of the rerouting grooves 474,474′ can be seen better in the detail enlargement of this region in FIG. 6.

### LIST OF REFERENCE NUMBERS

100 device, mixing head
101 control piston
102 cleaning piston
104 (first) spindle
104′ inverted spindle
106 (first) spindle nut
108 (first) coupling
110 (first) bearing device
112 (first) sealing flange
114 (first) thrust tube
116 (first) anti-rotation device
120 (first) housing
122 (first) electric drive
124 mixing chamber
126,126′ component-feeding opening
128 (first) servo motor
130 (first) coupling device
132 head piece
134 transfer mixing head
136 outlet chamber
144 (further/second) spindle
146 (further/second) spindle nut
148 (further/second) coupling
150 (further/second) bearing device
152 (further/second) sealing flange
154 (further/second) thrust tube
156 (further/second) anti-rotation device
160 (further/second) housing
162 (further/second) electric drive
164 (further/second) servo motor
166 (further/second) coupling device
168 mixing head outlet
470 linear mixing head
472,472′ return channel
474,474′ rerouting grooves

1. A device for mixing at least two chemically reactive plastics components under pressure, having a mixing chamber, into which the plastics components are injected in each case by way of a component-feeding opening, wherein a reversible control piston is provided for opening and closing the component-feeding openings and for discharging plastics mixture remaining within the mixing chamber, characterized in that the control piston is mechanically connected to an electric drive, wherein a movement of the electric drive brings about a linear movement of the control piston.

2. The device according to claim 1, wherein the electric drive is configured to generate a rotation movement, and the electric drive is connected to the control piston via a coupling device, wherein the coupling device is configured to convert the rotation movement of the electric drive into a linear movement of the control piston.

3. The device according to claim 1, wherein the electric drive is configured as a servo motor and/or stepping motor.

4. The device according to claim 1, wherein the electric drive is connected to a spindle, which drives a spindle nut, which in turn is connected to a thrust tube which is coupled to the control piston.

5. The device according to claim 4, wherein a bearing device, supporting the spindle, is arranged between the coupling and the spindle nut.

6. The device according to claim 4, in which the spindle is formed as an inverted spindle.

7. The device according to claim 6, wherein the electric drive is connected to a spindle nut, which drives the spindle, which in turn is connected to a thrust tube which is coupled to the control piston.

8. The device according to claim 7, wherein a bearing device is provided, which supports the spindle nut.

9. The device according to claim 1, which is configured as a transfer mixing head and has a cleaning piston, wherein an outlet chamber adjoins the mixing chamber, and the cleaning piston is arranged reversibly in the outlet chamber for discharging the reactive plastics mixture from the outlet chamber, and the cleaning piston is coupled to a further electric drive.

10. A device for mixing at least two chemically reactive plastics components under pressure, with a mixing chamber into which the plastics components are injected via respectively a component-feeding opening, wherein a reversible control piston is arranged for opening and closing the component-feeding openings and for discharging plastics mixture remaining within the mixing chamber, wherein the device is configured as a transfer mixing head and has a cleaning piston, wherein an outlet chamber adjoins the mixing chamber, and in the outlet chamber the cleaning piston is reversibly arranged for discharging the reactive plastics mixture from the outlet chamber,
characterized in that
the cleaning piston is coupled to a further electric drive.

11. The device according to claim 10, in which the control piston and the cleaning piston are arranged transversely with respect to one another, wherein the outlet chamber runs at an angle of 90° to the longitudinal axis of the mixing chamber.

12. The device according to claim 10, with respectively an anti-rotation device per thrust tube, which prevents a co-rotating of the thrust tube with the spindle.

13. A method for mixing at least two chemically reactive plastics components under pressure, wherein a reversible control piston is arranged in a cylindrical mixing chamber, into which the plastics components are injected via respectively a component-feeding opening, for opening and closing the component-feeding openings and for discharging plastics mixture remaining within the mixing chamber,
characterized in that
the control piston is connected to an electric drive and is driven by the latter, wherein a movement of the electric drive brings about a linear movement of the control piston.

14. The method according to claim 13, in which a cleaning piston is provided with an outlet chamber, which adjoins the mixing chamber, wherein in the outlet chamber a reversible cleaning piston is arranged for discharging the reactive plastics mixture from the outlet chamber, wherein additionally or alternatively to the control piston, the cleaning piston is connected to an electric drive and is driven by the latter.

15. The method according to claim 13, in which a current position of the cleaning piston and/or a current position of the control piston is determined and a control of the cleaning piston and/or of the control piston takes place using the respective determined current position.

16. The method according to claim 13, in which a throttle position of the cleaning piston is varied via an actuation of the electric drive which is associated with the cleaning piston.

17. The method according to claim 13, in which a speed profile of the cleaning piston and/or a speed profile of the control piston are/is varied as a function of the produced part.

18. The method according to claim 13, in which the electric drive which is associated with the control piston is actuated in such a way that the control piston approaches an intermediate position, in order to flush rerouting grooves in the control piston.

19. The method according to claim 13, in which a torque and/or a rotation speed and/or an electric current consumption of the electric drive of the cleaning piston and/or of the electric drive of the control piston are/is monitored, and a wear parameter for prospective maintenance is determined using the rotation speed and/or the torque and/or the electric current consumption.
